(19) United States
(12) Patent Application Publication
(10) Pub. No.: US 2026/0095529 A1
(43) Pub. Date: Apr. 2, 2026

(54) DEVICE INCLUDING REPLACEABLE COMPONENT, USER INTERFACE, AND CONTROLLER CONFIGURED TO CAUSE USER INTERFACE TO OPERATE IN BOTH REPLACEMENT ENABLED MODE AND REPLACEMENT DISABLED MODE

(71) Applicant: BROTHER KOGYO KABUSHIKI KAISHA, Nagoya (JP)

(72) Inventor: Satoru ARAKANE, Nagoya (JP)

(73) Assignee: BROTHER KOGYO KABUSHIKI KAISHA, Nagoya (JP)

(21) Appl. No.: 19/335,203

(22) Filed: Sep. 22, 2025

(30) Foreign Application Priority Data
Oct. 2, 2024 (JP) 2024-173204

(51) Int. Cl. H04N 1/00; G06F 9/451

(52) U.S. Cl. CPC H04N 1/00384; G06F 9/451

(57) ABSTRACT

A device includes: a replaceable component; a user interface; and a controller. The user interface is operable by a user. The controller is configured to: cause the user interface to operate in both: a replacement enabled mode in which a replacement initiation operation on the user interface is enabled; and a replacement disabled mode in which the replacement initiation operation on the user interface is disabled. The replacement initiation operation is an operation for initiating replacement of the replaceable component.

### REFERENCE TO RELATED APPLICATIONS

This application claims priority from Japanese Patent Application No. 2024-173204 filed on Oct. 2, 2024. The entire content of the priority application is incorporated herein by reference.

### BACKGROUND ART

As an example of a device including replaceable components, there has been known a printing device including a print head as a replaceable component. In this printing device, when a user wishes to replace the print head, the user can perform an operation in a settings screen displayed on an operation panel. This operation causes the operation panel to display another screen inquiring whether the user wishes to execute a process of replacing the print head. When a “Yes” button has been pressed in this screen, an unlock screen is displayed for unlocking a front door of the printing device. As the user presses an “Unlock” button in the unlock screen, the printing device unlocks the front door and performs a head replacement preparation process to allow replacement of the print head.

### SUMMARY

As described above, the known printing device can display a screen asking whether the user wishes to perform a process of replacing the print head whenever the user performs an operation in the settings screen displayed on the operation panel. Consequently, the user can perform the operation to display the screen asking the user whether to execute the process of replacing the print head, even in a state where the print head cannot be replaced. This configuration may result in confusion. For example, the user may be led to believe incorrectly that the print head can be replaced, even when the print head is not in a replaceable state.

In view of the foregoing, it is an object of the present disclosure to provide a device including replaceable components, an external device connected to a device including replaceable components so as to communicate with the same, a non-transitory computer-readable storage medium storing a set of program instructions for a device including replaceable components, and a method of controlling a device including replaceable components that enable a user to replace the replaceable components properly.

In order to attain the above and other objects, the present disclosure provides a device including: a replaceable component; a user interface; and a controller. The user interface is operable by a user. The controller is configured to: cause the user interface to operate in both: a replacement enabled mode in which a replacement initiation operation on the user interface is enabled; and a replacement disabled mode in which the replacement initiation operation on the user interface is disabled. The replacement initiation operation is an operation for initiating replacement of the replaceable component.

The above configuration of the device enables the replacement initiation operation for initiating the replacement of the replaceable component to be performed on the user interface only when the replacement of the replaceable component is appropriate, for example, when the replacement of the replaceable component can be performed or when the necessity to replace the replaceable component is high.

According to another aspect, the present disclosure also provides an external device including: a communication interface; a user interface; and a controller. The communication interface is configured to communicate with a device including a replaceable component. The user interface is operable by a user. The controller is configured to: cause the user interface to operate in both: a replacement enabled mode in which a replacement initiation operation on the user interface is enabled; and a replacement disabled mode in which the replacement initiation operation on the user interface is disabled. The replacement initiation operation is an operation for initiating replacement of the replaceable component on the device.

The above configuration of the external device enables the replacement initiation operation for initiating the replacement of the replaceable component to be performed on the user interface only when the replacement of the replaceable component in the device is appropriate, for example, when the replacement of the replaceable component can be performed in the device or when the necessity to replace the replaceable component in the device is high.

According to still another aspect, the present disclosure provides a non-transitory computer-readable storage medium storing a set of program instructions for a device including a replaceable component and a user interface operable by a user. The set of program instructions, when executed by a computer, causes the device to perform: causing the user interface to operate in both: a replacement enabled mode in which a replacement initiation operation on the user interface is enabled; and a replacement disabled mode in which the replacement initiation operation on the user interface is disabled. The replacement initiation operation is an operation for initiating replacement of the replaceable component.

According to still another aspect, the present disclosure provides a method of controlling a device including: a replaceable component; and a user interface operable by a user. The method includes: causing the user interface to operate in both: a replacement enabled mode in which a replacement initiation operation on the user interface is enabled; and a replacement disabled mode in which the replacement initiation operation on the user interface is disabled. The replacement initiation operation is an operation for initiating replacement of the replaceable component.

The configurations of the non-transitory computer-readable storage medium and the method described above enable the replacement initiation operation for initiating the replacement of the replaceable component to be performed on the user interface only when the replacement of the replaceable component is appropriate, for example, when the replacement of the replaceable component can be performed or when the necessity to replace the replaceable component is high.

### BRIEF DESCRIPTION OF DRAWINGS

FIG. 1 is a diagram illustrating an overall configuration of a printer.

FIG. 2 is a block diagram illustrating an electrical configuration of the printer.

FIG. 3A illustrates one example of a settings screen.

FIG. 3B is a flowchart illustrating a process executed when a “Maintenance” selection button has been selected.

FIG. 4A illustrates one example of a first maintenance selection screen.

FIG. 4B illustrates one example of a second maintenance selection screen.

FIG. 5A illustrates one example of a cartridge replacement screen.

FIG. 5B illustrates one example of a tank replacement screen.

FIG. 6A illustrates one example of a head replacement screen.

FIG. 6B illustrates one example of a head information entry screen.

FIG. 6C illustrates one example of information indicated on a head.

FIG. 7 illustrates one example of a first maintenance selection screen in which a “Replace head” selection button has been grayed out.

FIG. 8 is a flowchart illustrating a process executed when the “Maintenance” selection button has been selected.

FIG. 9 is a flowchart illustrating a process executed when the “Maintenance” selection button has been selected.

FIG. 10 is a flowchart illustrating a process executed when the “Maintenance” selection button has been selected.

FIG. 11A is a flowchart illustrating a process executed when the “Maintenance” selection button has been selected.

FIG. 11B is a flowchart illustrating a process executed when the “Maintenance” selection button has been selected.

FIG. 12 is a diagram illustrating a configuration of an ejection inspection unit included in a purge unit.

FIG. 13A is a graph illustrating a waveform of a signal outputted from a signal processing circuit when a nozzle is a normal nozzle.

FIG. 13B is a graph illustrating a waveform of a signal outputted from the signal processing circuit when the nozzle is an abnormal nozzle.

FIG. 14 is a flowchart illustrating a process executed when the “Maintenance” selection button has been selected.

FIG. 15A is a block diagram illustrating an electrical configuration of a printer including a paper jam detection sensor.

FIG. 15B is a flowchart illustrating a process executed when the “Maintenance” selection button has been selected.

FIG. 16 is a diagram illustrating one example of physical buttons included in a printer that are operable by a user.

FIG. 17 is a block diagram illustrating an electrical configuration of a system including a printer and an external device connected to the printer.

FIG. 18 is a flowchart illustrating a process executed when a “Maintenance” selection button has been selected.

### DESCRIPTION

Hereinafter, one embodiment of the present disclosure will be described.

### Overall Configuration of Printer

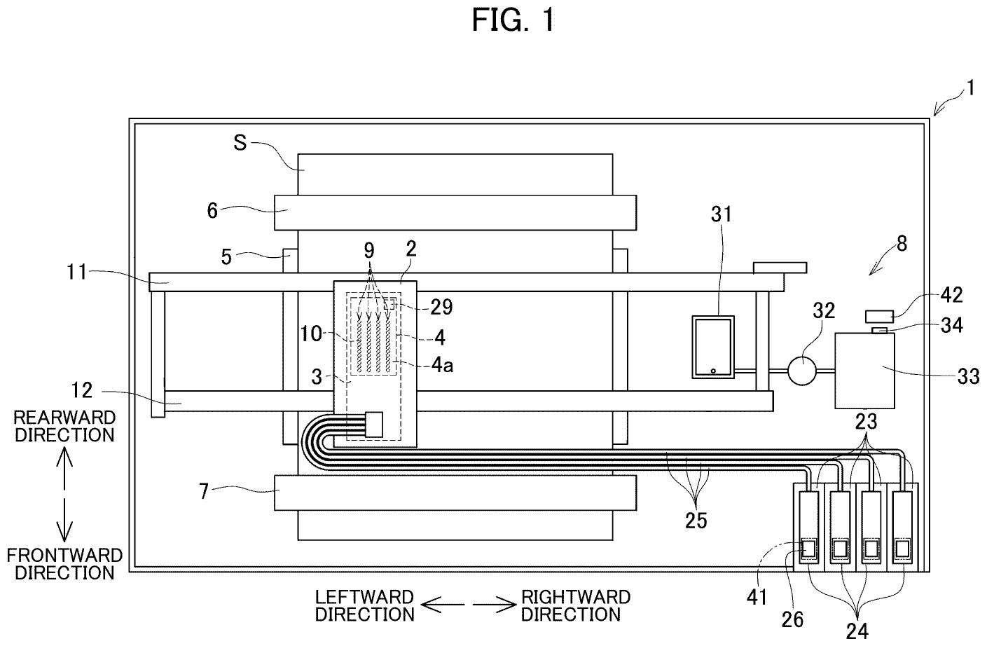

A printer 1 according to the present embodiment is illustrated in FIG. 1. The printer 1 includes a carriage 2, a sub-tank 3, a head 4, a platen 5, conveying rollers 6 and 7, and a purge unit 8. The printer 1 is an example of the “device” and is an example of the “image recording device”. The head 4 is an example of the claimed “replaceable component”.

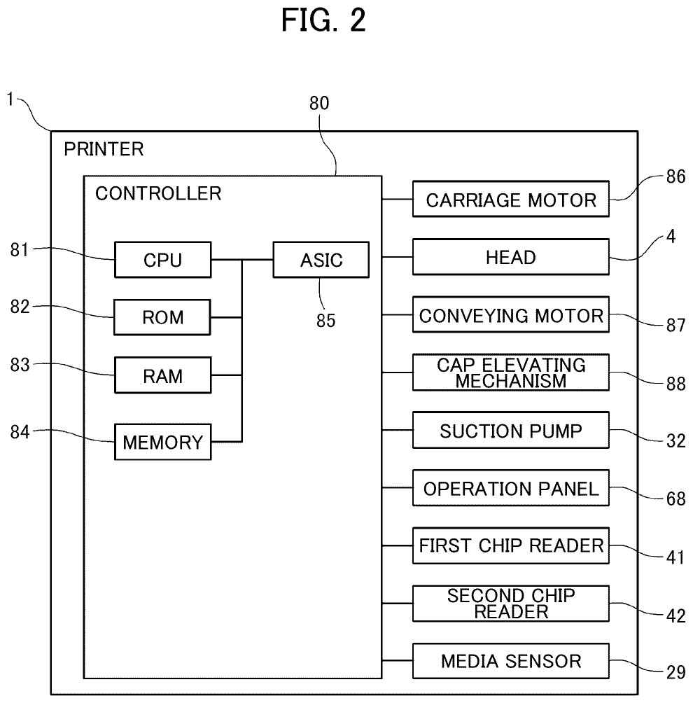

The carriage 2 is supported on two guide rails 11 and 12 that extend in leftward and rightward directions. The two guide rails 11 and 12 are spaced apart from each other in frontward and rearward directions. The carriage 2 is connected to a carriage motor 86 illustrated in FIG. 2 through a belt (not illustrated), for example. The carriage motor 86 is configured to be driven to move the carriage 2 in the leftward and rightward directions along the guide rails 11 and 12.

In the present embodiment, the leftward direction is a direction that is parallel to the horizontal direction, and the rightward direction is a direction that is opposite the leftward direction. Further, in the present embodiment, the frontward direction is a direction that is parallel to the horizontal direction and is orthogonal to both the leftward direction and the rightward direction, and the rearward direction is a direction that is opposite the frontward direction.

The sub-tank 3 is mounted in the carriage 2. The printer 1 includes four cartridge attachment portions 23 arranged in the leftward and rightward directions at a right-front corner region in the printer 1. An ink cartridge 24 is detachably attached to each of the cartridge attachment portions 23. The ink cartridges 24 attached to the respective cartridge attachment portions 23 store ink in the colors of black, yellow, cyan, and magenta in order from the ink cartridge 24 positioned farthest rightward. The sub-tank 3 is connected to the four ink cartridges 24 attached to the cartridge attachment portions 23 through four tubes 25. Accordingly, the four colors of ink described above are configured to be supplied to the sub-tank 3 from the four ink cartridges 24. Each of the ink cartridges 24 is an example of the claimed “second replaceable component”.

An IC chip 26 is disposed on a surface of each of the ink cartridges 24. Each of the IC chips 26 stores information related to the corresponding one of the ink cartridges 24. The information related the ink cartridge 24 includes the serial number of the ink cartridge 24 and the type of ink stored in the ink cartridge 24, for example. Each of the cartridge attachment portions 23 includes a first chip reader 41 configured to read information from the IC chip 26 of the corresponding ink cartridge 24. The first chip reader 41 is an example of the claimed “reader”.

The head 4 is connected to a lower end portion of the sub-tank 3. The head 4 has a lower surface serving as a nozzle surface 4a. The nozzle surface 4a is formed with a plurality of nozzles 10. The head 4 is configured to eject ink through the plurality of nozzles 10. Specifically, the head 4 has four nozzle rows 9 juxtaposed in the leftward and rightward directions. Each of the four nozzle rows 9 are formed by some of the plurality of nozzles 10 that are arranged in the frontward and rearward directions. Through the nozzles 10 forming the nozzle rows 9, ink is ejected in the respective colors black, yellow, cyan, and magenta in order from the nozzle row 9 positioned farthest rightward. Ink in each of these four colors is to be supplied to the head 4 from the sub-tank 3. The head 4 also includes a media sensor 29. The media sensor 29 functions to detect when a recording sheet S supplied from a feeding unit (not illustrated) has reached a position opposing the media sensor 29. The recording sheet S is an example of the claimed “recording medium”and the claimed “recording media”.

The platen 5 is disposed below the carriage 2 and the head 4. The platen 5 has a substantially rectangular parallelepiped shape.

The conveying rollers 6 and 7 are rollers whose axial directions are parallel to the leftward and rightward directions. The conveying rollers 6 are disposed further rearward relative to both the carriage 2 and the platen 5, while the conveying rollers 7 are disposed further frontward relative to both the carriage 2 and the platen 5. The conveying rollers 6 and 7 are connected to a conveying motor 87 illustrated in FIG. 2 via gears (not illustrated), for example. As the conveying motor 87 is driven, the conveying rollers 6 and 7 rotate to convey recording sheets S in the frontward direction.

The purge unit 8 includes a cap 31, a suction pump 32, and a waste liquid tank 33. The waste liquid tank 33 is an example of the claimed “second replaceable component”.

The cap 31 is disposed further rightward relative to the platen 5. When the carriage 2 has been moved rightward to be positioned at a purging position which is further rightward relative to the platen 5, the nozzles 10 oppose the cap 31.

The cap 31 is connected to a cap elevating mechanism 88 illustrated in FIG. 2. The cap elevating mechanism 88 is configured to be driven to cause the cap 31 to be raised and lowered. While the nozzles 10 oppose the cap 31 as a result of the movement of the carriage 2 to the purging position, the cap 31 is raised by the cap elevating mechanism 88. When the cap 31 is raised, an upper end portion of the cap 31 is brought into intimate contact with the nozzle surface 4a, thereby making the nozzles 10 in a capped state in which the nozzles 10 are covered by the cap 31. In a state where the cap 31 is lowered, the cap 31 does not cover the nozzles 10.

Note that the cap 31 may not be in intimate contact with the nozzle surface 4a in order to cover the nozzles 10. For example, the cap 31 may cover the nozzles 10 by being in firm contact with a frame (not illustrated) disposed around the nozzle surface 4a of the head 4.

The suction pump 32 is a tube pump, for example, and is connected to both the cap 31 and the waste liquid tank 33. As the suction pump 32 is driven while the nozzles 10 are in the capped state, the purge unit 8 performs a suction purge to cause ink in the head 4 to be discharged through the nozzles 10. Ink discharged with the suction purge is to be stored in the waste liquid tank 33.

Note that, for convenience, the above description has been made while assuming that the cap 31 is configured to cover all of the nozzles 10 collectively to cause ink to be discharged from the head 4 through all the nozzles 10 during the suction purge. However, configurations different from that described above may be employed. For example, the cap 31 may include two separate parts, i.e., one part configured to cover the nozzles 10 constituting the rightmost nozzle row 9 for ejecting black ink, and the other part configured to cover the nozzles 10 constituting the first through third nozzle rows 9 from the left for ejecting color ink. With this configuration, selected one of black ink and color ink can be discharged from the head 4 during the suction purge. Here, “color ink” refers to ink in the colors yellow, cyan, and magenta. As an alternative, one cap 31 may be disposed for each of the nozzle rows 9. In this way, suction purges can be performed to discharge ink through nozzles 10 in each of the nozzle rows 9 independently.

An IC chip 34 is positioned on a surface of the waste liquid tank 33. The IC chip 34 stores information related to the waste liquid tank 33. For example, the information related the waste liquid tank 33 includes the serial number of the waste liquid tank 33 and information on the capacity of the waste liquid tank 33. Corresponding to the IC chip 34, the printer 1 also includes a second chip reader 42 configured to read the information stored in the IC chip 34. The second chip reader 42 is also an example of the claimed “reader”.

### Electrical Configuration of Printer

Next, the electrical configuration of the printer 1 will be described. As illustrated in FIG. 2, the printer 1 further includes a controller 80. The controller 80 includes a CPU 81, a ROM 82, a RAM 83, a memory 84, and an ASIC 85. “CPU” is an abbreviation of “central processing unit”. “ROM” is an abbreviation of “read-only memory”. “RAM” is an abbreviation of “random-access memory”. “ASIC” is an abbreviation of “application-specific integrated circuit”.

The controller 80 is configured to control operations of the carriage motor 86, the head 4, the conveying motor 87, the cap elevating mechanism 88, the suction pump 32, the first chip reader 41, and the second chip reader 42. The controller 80 is also configured to receive signals from the first chip reader 41, the second chip reader 42, and the media sensor 29.

In addition to the above configuration, the printer 1 further includes an operation panel 68. The operation panel 68 is constituted by forming a display unit such as a liquid crystal display, and an operation unit such as a touchscreen as a single member. The controller 80 is configured to control operations of the operation panel 68 and to receive signals from the operation panel 68. That is, the operation panel 68 serves as a user interface that is operable by a user. The operation panel 68 is an example of the claimed “user interface” and is also an example of the “display”.

The controller 80 may be configured such that only the CPU 81 is configured to perform various processes, only the ASIC 85 is configured to perform various processes, or both the CPU 81 and the ASIC 85 are configured to perform various processes in cooperation with each other. Moreover, the controller 80 may have a single CPU 81 configured to perform processes alone or a plurality of CPUs 81 configured to share the processes. Alternatively, the controller 80 may have a single ASIC 85 configured to perform the processes alone or a plurality of ASICs 85 configured to share the processes.

### Controls during Recording of Images

Next, a process performed by the controller 80 when images are recorded on recording sheets S in the printer 1 will be described. The controller 80 controls the printer 1 to repeatedly perform a recording pass and a conveying operation to record images on recording sheets S. In the recording pass, the controller 80 controls the carriage motor 86 to move the carriage 2 in the leftward and rightward directions while controlling the head 4 to eject ink toward the recording sheet S through the nozzles 10. In the conveying operation, the controller 80 controls the conveying motor 87 to convey the recording sheet S in the frontward direction using the conveying rollers 6 and 7.

### Maintenance

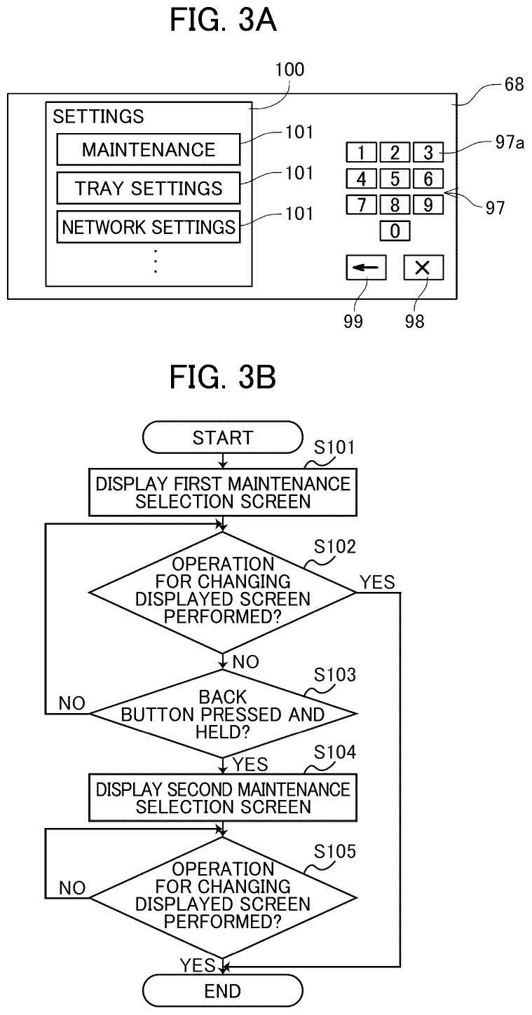

Various types of maintenance can be performed on the printer 1. More specifically, when a predetermined operation is performed on the operation panel 68, a settings screen 100 illustrated in FIG. 3A is displayed on the operation panel 68 under the control of the controller 80.

The settings screen 100 includes a plurality of selection buttons 101. FIG. 3A illustrates a case in which the selection buttons 101 include a selection button 101 for each of “Maintenance”, “Tray settings”, and “Network settings”. The user can select a button by touching the operation panel 68 in the area where the button is displayed. The buttons displayed on the operation panel 68 are each an example of the “operation button”.

The “Maintenance” selection button 101 is selected to perform maintenance, which will be described later in detail. The “Tray settings” selection button 101 is selected to configure settings related to feeding trays (not illustrated) that function to feed recording sheets S. The “Network settings” selection button 101 is selected to connect the printer 1 to a network. Note that a detailed description of operations performed when the “Tray settings” and “Network settings” selection buttons 101 have been selected will be omitted here. Note that the plurality of selection buttons 101 other than the “Maintenance” selection button 101 may include selection buttons 101 that are selected to perform different operations from those described above.

Additionally, a back button 99, an end button 98, and a numeric keypad 97 are always displayed on a right end region of the operation panel 68. When the back button 99 is selected while any of various screens such as the settings screen 100 is displayed on the operation panel 68, the controller 80 ends display of a screen currently displayed on the operation panel 68 and displays a screen that was displayed on the operation panel 68 immediately before the screen that is currently displayed. When the end button 98 is selected while any of various screens such as the settings screen 100 is displayed on the operation panel 68, the controller 80 ends display of the screen currently displayed on the operation panel 68 and returns the screen to an initial screen (not illustrated). The screen currently displayed on the operation panel 68 is an example of the claimed “current screen”. The screen displayed on the operation panel 68 immediately before the screen currently displayed on the operation panel 68 is an example of the claimed “previous screen”.

When the end button 98 is selected while the printer 1 performs image recording on recording sheets S, such image recording is halted. The numeric keypad 97 includes numeric buttons 97a, including buttons from “0” to “9”. The numeric keypad 97 is used for inputting various information including information on the head 4, as will be described later.

When the “Maintenance” selection button 101 is selected in the settings screen 100, the controller 80 executes a process illustrated in the flowchart in FIG. 3B to display a first maintenance selection screen 110A and a second maintenance selection screen 110B (described later). The ROM 82 stores programs executed by the CPU 81. The controller 80 performs the process according to the flowchart in FIG. 3B by the CPU 81 executing a program stored in the ROM 82. This also applies to processes that the controller 80 performs in accordance with the flowcharts described later. The controller 80 including the CPU 81 configured to execute the above program is an example of the claimed “computer”.

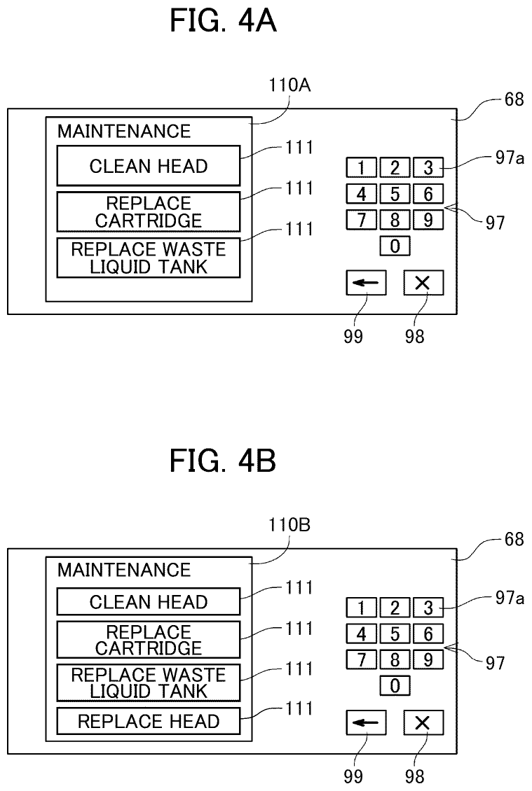

The process in the flowchart in FIG. 3B will be described in detail. In S101 the controller 80 first displays the first maintenance selection screen 110A illustrated in FIG. 4A on the operation panel 68. The first maintenance selection screen 110A includes a plurality of selection buttons 111 including a selection button 111 for each of “Clean head”, “Replace cartridge”, and “Replace waste liquid tank”.

When the “Clean head” selection button 111 is selected, the controller 80 controls the carriage motor 86, the cap elevating mechanism 88, and the suction pump 32 to perform the suction purge described above. After completing the suction purge, the controller 80 displays a suitable screen, such as the initial screen (not illustrated), on the operation panel 68.

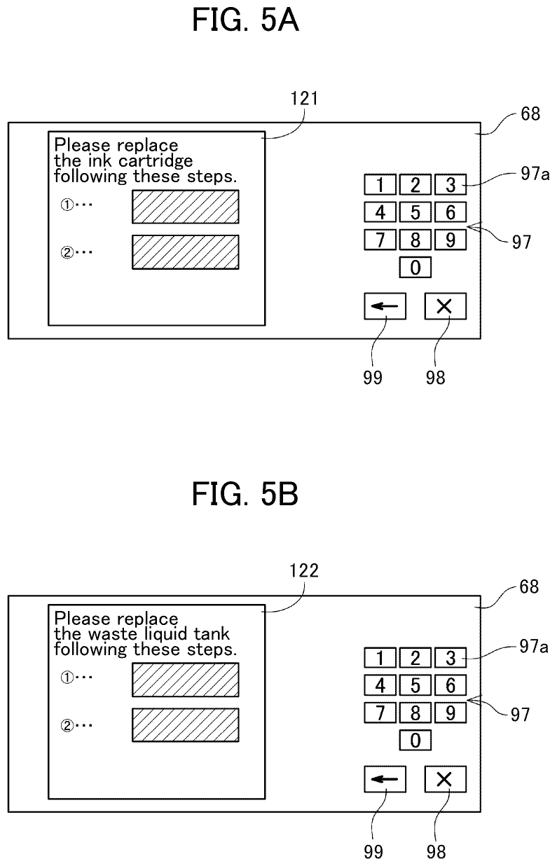

When the “Replace cartridge” selection button 111 is selected, the controller 80 displays a cartridge replacement screen 121 illustrated in FIG. 5A on the operation panel 68. The cartridge replacement screen 121 describes the procedure for replacing the ink cartridge 24. In accordance with the description in the cartridge replacement screen 121, the user can replace the ink cartridge 24 by removing the ink cartridge 24 currently attached to the cartridge attachment portion 23 and attaching a new ink cartridge 24 to the cartridge attachment portion 23. Upon attachment of the new ink cartridge 24 to the cartridge attachment portions 23, the controller 80 obtains information on the ink cartridge 24 by controlling the first chip reader 41 to read the information stored in the IC chip 26 of the ink cartridge 24. As a result, the controller 80 can detect the completion of replacement of the ink cartridge 24 based on the change in information obtained from the IC chip 26.

When the “Replace waste liquid tank” selection button 111 is selected, the controller 80 displays a tank replacement screen 122 illustrated in FIG. 5B on the operation panel 68. The tank replacement screen 122 describes the procedure for replacing the waste liquid tank 33. In accordance with the description in the tank replacement screen 122, the user can replace the waste liquid tank 33 by removing the current waste liquid tank 33 from the printer 1 and mounting a new waste liquid tank 33 in the printer 1. Once the new waste liquid tank 33 has been mounted, the controller 80 obtains information on the waste liquid tank 33 by controlling the second chip reader 42 to read the information stored in the IC chip 34 of the waste liquid tank 33. As a result, the controller 80 can detect the completion of replacement of the waste liquid tank 33 based on the change in information obtained from the IC chip 34.

Referring back to FIG. 3B, after the controller 80 displays the first maintenance selection screen 110A on the operation panel 68 in S101, in S102 and S103 the controller 80 waits until an operation for changing the screen displayed on the operation panel 68 is performed or the back button 99 is pressed and held (S102: NO, S103: NO). Here, an operation that changes the screen displayed on the operation panel 68 is an operation of selecting one of the back button 99 and the end button 98, for example.

Further, “the back button 99 is pressed and held” denotes that the user has touched the area of the operation panel 68 that displays the back button 99 and continues to touch the same area of the operation panel 68 for a predetermined period of time or longer. In contrast, “the back button 99 is selected” denotes that the user has touched the area of the operation panel 68 that displays the back button 99 but that the period of time during which the user has touched this area of the operation panel 68 is less than the predetermined period of time. In other words, when the user touches the area of the operation panel 68 that displays the back button 99, the controller 80 determines whether the back button 99 has been selected or pressed and held on the basis of whether the period of time during which the user has touched the area of the operation panel 68 is greater than or equal to the predetermined period of time. The end button 99 is an example of the claimed “specific button”.

When an operation that changes the screen displayed on the operation panel 68 is performed (S102: YES), the controller 80 ends the process according to the flowchart in FIG. 3B. At this time, the controller 80 executes a process corresponding to the selected button.

On the other hand, when the back button 99 is pressed and held (S102: NO and S103: YES), in S104 the controller 80 displays the second maintenance selection screen 110B illustrated in FIG. 4B on the operation panel 68. The second maintenance selection screen 110B includes the selection buttons 111 similar to the first maintenance selection screen 110A. However, in addition to the selection buttons 111 for “Clean head”, “Replace cartridge”, and “Replace waste liquid tank” in the first maintenance selection screen 110A, the selection buttons 111 in the second maintenance selection screen 110B include a “Replace head” selection button 111.

The “Replace head” selection button 111 is an example of the claimed “replacement initiation button”. The operation for selecting the “Replace head” selection button 111 is an example of the claimed “replacement initiation operation”. The operation for selecting the “Replace cartridge” selection button 111 in the first maintenance selection screen 110A or the second maintenance selection screen 110B is an example of the claimed “second replacement initiation operation”. The operation for selecting the “Replace waste liquid tank” selection button 111 in the first maintenance selection screen 110A or the second maintenance selection screen 110B is also an example of the claimed “second replacement initiation operation”. The second maintenance screen 110B, which includes the “Replace head” selection screen 111, is an example of the claimed “first screen”.

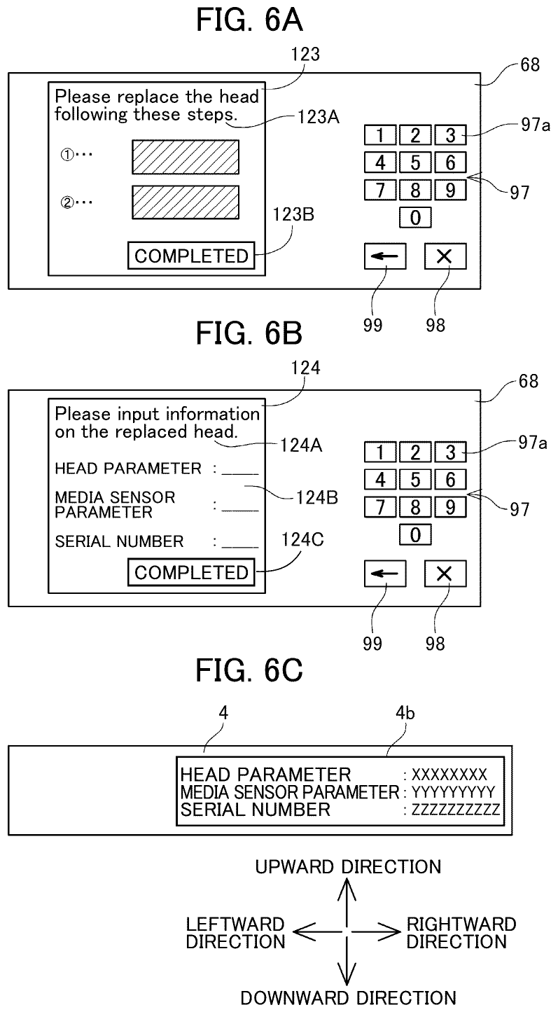

When the “Replace head” selection button 111 is selected, the controller 80 displays a head replacement screen 123 illustrated in FIG. 6A on the operation panel 68. The head replacement screen 123 includes a message section 123A, and a Completed button 123B.

The message section 123A includes a message prompting the user to replace the head 4, and a description of the procedure for replacing the head 4. In accordance with the description displayed in the head replacement screen 123, the user can replace the head 4 by removing the current head 4 from the carriage 2 and mounting a new head 4 in the carriage 2.

The user selects the Completed button 123B after replacement of the head 4 has been completed. When the Completed button 123B is selected, the controller 80 displays a head information entry screen 124 illustrated in FIG. 6B on the operation panel 68. The head information entry screen 124 includes a message section 124A, an input display section 124B, and a Completed button 124C.

The message section 124A includes a message prompting the user to input information on the replaced head 4, such as a head parameter, a media sensor parameter, and a serial number for the head 4. The head parameter indicates the quality rank of the head 4, for example. The media sensor parameter indicates the degree of inclination of the media sensor 29 in the head 4, for example. The serial number is a unique number assigned to the head 4 at the time of manufacture.

The inputted head parameter, media sensor parameter, and serial number are displayed in the input display section 124B. The user can enter the head parameter, the media sensor parameter, and the serial number by selecting numeric buttons 97a in the numeric keypad 97. In the present embodiment, a sticker 4b indicating the head parameter, the media sensor parameter, and the serial number is affixed to a front surface of the head 4, as illustrated in FIG. 6C, for example. Thus, the user can input the head parameter, the media sensor parameter, and the serial number indicated on the head 4. Alternatively, an insert providing information on the head parameter, the media sensor parameter, and the serial number may be included with the head 4 for replacement at the time of purchase. In this case, the user may input the head parameter, the media sensor parameter, and the serial number indicated on the insert.

While the head parameter, the media sensor parameter, and the serial number are to be inputted as the information on the head 4 in the present embodiment, some of these items may be inputted as the information on the head 4. Alternatively, the user may input information different from the items given above as the information on the head 4.

The Completed button 124C is selected by the user after input of the head parameter, the media sensor parameter, and the serial number has been completed. When the Completed button 124C is selected, the controller 80 displays a suitable screen, such as the initial screen (not illustrated), and obtains the head parameter, the media sensor parameter, and the serial number for the replaced head 4 which were inputted by the user. Note that, in a case where only the serial number for the head 4 is to be inputted as the information on the head 4, the controller 80 may obtain the information on the head parameter, the media sensor parameter, and the serial number for the replaced head 4 on the basis of the inputted serial number for the head 4, for example. On the basis of the obtained information on the head 4, the controller 80 then performs a setup to adjust the drive voltage and the drive waveform for the head 4, for example.

Returning to FIG. 3B, after displaying the second maintenance selection screen 110B on the operation panel 68 in S104, in S105 the controller 80 waits until an operation of changing the screen displayed on the operation panel 68 is performed (S105: NO). When an operation for changing the screen displayed on the operation panel 68 is performed (S105: YES), the controller 80 ends the process according to the flowchart of FIG. 3B. At this time, the controller 80 executes a process corresponding to the operation performed on the second maintenance selection screen 110B, whereby the screen displayed on the operation panel 68 is changed to a different screen from the second maintenance selection screen 110B. The different screen from the second maintenance selection screen 110B is an example of the claimed “second screen”.

In this way, by displaying on the operation panel 68 the first maintenance selection screen 110A, which does not include the “Replace head” selection button 111, the controller 80 in the present embodiment can cause the operation panel 68 to operate in a replacement operation disabled mode for disabling an operation of selecting the “Replace head” selection button 111. Further, by displaying the second maintenance selection screen 110B, which includes the “Replace head” selection button 111, on the operation panel 68, the controller 80 in the present embodiment can place the operation panel 68 in a replacement operation enabled mode for enabling an operation of selecting the “Replace head” selection button 111.

As described above, the controller 80 in the present embodiment ends the process in accordance with the flowchart of FIG. 3B when the screen displayed on the operation panel 68 is switched from the second maintenance selection screen 110B to a screen other than the second maintenance selection screen 110B. Therefore, when the settings screen 100 in FIG. 3A is later displayed on the operation panel 68 and the “Maintenance” selection button 101 is selected in the settings screen 100, the controller 80 restarts the process according to the flowchart in FIG. 3B and in S101 redisplays the first maintenance selection screen 110A on the operation panel 68. In other words, when the screen displayed on the operation panel 68 is changed to a different screen than the second maintenance selection screen 110B, the controller 80 shifts an operation mode of the operation panel 68 from a selection operation enabled mode in which an operation of selecting the “Replace head” selection button 111 is enabled to a selection operation disabled mode in which an operation of selecting the “Replace head” selection button 111 is disabled.

In the above description, the process according to the flowchart in FIG. 3B is started when the “Maintenance” selection button 101 is selected in the settings screen 100. However, the present disclosure is not limited to this operation. The controller 80 may start the process according to the flowchart in FIG. 3B at another timing when the first maintenance selection screen 110A or the second maintenance selection screen 110B is to be displayed on the operation panel 68. For example, when the first maintenance selection screen 110A or the second maintenance selection screen 110B is displayed on the operation panel 68 and an operation is performed to change the screen displayed on the operation panel 68, causing the controller 80 to end the process according to the flowchart in FIG. 3B, the controller 80 may restart the process according to the flowchart in FIG. 3B in response to the back button 99 being selected while a different screen is displayed on the operation panel 68 as a result of the above operation.

### Advantages of Embodiment

In the present embodiment, the controller 80 causes the operation panel 68 to operate in both a replacement enabled mode in which the second maintenance selection screen 110B is displayed to enable the “Replace head” selection button 111 to be selected, and a replacement disabled mode in which the first maintenance selection screen 110A is displayed to disable the “Replace head” selection button 111 from being selected. This configuration enables the user to select the “Replace head” selection button 111 on the operation panel 68 only when replacing the head 4 is appropriate. Note that the replacement operation enabled mode and the selection operation enabled mode which are described above correspond to the replacement enabled mode, while the replacement operation disabled mode and the selection operation disabled mode correspond to the replacement disabled mode.

Further, by placing the operation panel 68 in the replacement enabled mode in the above embodiment to display on the operation panel 68 the second maintenance selection screen 110B, which includes the “Replace head” selection button 111, the user can be made aware that replacement of the head 4 can be initiated. On the other hand, by operating the operation panel 68 in the replacement disabled mode so that the first maintenance selection screen 110A, which does not include the “Replace head” selection button 111, is displayed on the operation panel 68, the printer 1 can avoid misleading the user into thinking that the user can initiate replacement of the head 4.

In the above embodiment, when the first maintenance selection screen 110A, which does not include the “Replace head” selection button 111, is displayed on the operation panel 68 and the user presses and holds the back button 99, which is displayed on the operation panel 68 and is not normally pressed and held, the controller 80 displays the second maintenance selection screen 110B, which includes the “Replace head” selection button 111, on the operation panel 68. In other words, when the back button 99, which is displayed on the operation panel 68 and is not normally pressed and held, is pressed and held while the operation panel 68 is operated in the replacement disabled mode, the controller 80 switches the operation mode of the operation panel 68 to the replacement enabled mode. This operation can restrict the user from accidentally shifting the operation panel 68 into the replacement enabled mode to display the second maintenance selection screen 110B on the operation panel 68.

In the above embodiment, operations for replacing the head 4 are more difficult than those for replacing the ink cartridge 24 and the waste liquid tank 33. Moreover, the controller 80 causes the operation panel 68 to prompt the user to input information on the head 4 when the replacement of the head 4 is completed, but does not cause the operation panel 68 to prompt the user to input information when the replacement of the ink cartridge 24 or the waste liquid tank 33 is completed. From this perspective, the head 4 is more difficult to replace than the ink cartridge 24 and the waste liquid tank 33.

Therefore, in the present embodiment, an operation of selecting the “Replace head” selection button 111, i.e., an operation of initiating replacement of the head 4, which is more difficult to replace, can be performed in a state where the operation panel 68 operates in the replacement enabled mode but cannot be performed in a state where the operation panel 68 operates in the replacement disabled mode. This operation can restrict the user from accidentally shifting the operation panel 68 into the replacement enabled mode and performing an operation of selecting the “Replace head” selection button 111.

In contrast, an operation of selecting the “Replace cartridge” and “Replace waste liquid tank” selection buttons 111 for initiating replacement of the ink cartridge 24 and the waste liquid tank 33, which are less difficult to replace, is enabled regardless of whether the operation panel 68 operates in the replacement enabled mode or in the replacement disabled mode. This operation can simplify the operations for replacing the ink cartridge 24 and the waste liquid tank 33.

In the above embodiment, the ink cartridge 24 and the waste liquid tank 33 include respective the IC chips 26 and 34, which are configured to be read by the respective first and second chip readers 41 and 42. The controller 80 can detect the completion of replacement of the ink cartridge 24 and the waste liquid tank 33 on the basis of the reading results of the corresponding first and second chip readers 41 and 42. In contrast, the head 4 does not include an IC chip, and the controller 80 cannot detect the completion of replacement of the head 4. Therefore, if the “Replace head” selection button 111 were made easy to select, the controller 80 would be unable to determine whether the head 4 was actually replaced or the user inadvertently selected the “Replace head” selection button 111.

Therefore, the printer 1 in the above embodiment is configured to enable the user to select the “Replace head” selection button 111, i.e., to perform an operation for initiating replacement of the head 4, whose replacement cannot be detected, while the operation panel 68 operates in the replacement enabled mode, but to disable this selection while the operation panel 68 operates in the replacement disabled mode. This configuration can restrict the user from accidentally shifting the operation panel 68 into the replacement enabled mode and performing an operation of selecting the “Replace head” selection button 111.

On the other hand, the printer 1 enables the user to select the “Replace cartridge” and “Replace waste liquid tank” selection buttons 111 for initiating the replacement of the ink cartridge 24 and the waste liquid tank 33, whose replacement can be detected, regardless of whether the operation panel 68 operates in the replacement enabled mode or in the replacement disabled mode. This configuration can simplify the operations for replacing the ink cartridge 24 and the waste liquid tank 33.

In the above embodiment, when the operation panel 68 is operated in the replacement enabled mode and the screen displayed on the operation panel 68 is switched from the second maintenance selection screen 110B to another screen, the controller 80 displays the first maintenance selection screen 110A on the operation panel 68 if the “Maintenance” selection button 101 is later selected in the settings screen 100. In other words, the controller 80 causes the operation panel 68 to operate in the replacement disabled mode. This configuration can restrict the operation panel 68 from continuing to operate in the replacement enabled mode unnecessarily.

### Modifications

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art.

Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

For example, in the above embodiment, an operation of selecting the “Replace head” selection button 111 is disabled by not displaying the “Replace head” selection button 111 in the first maintenance selection screen 110A. However, the present disclosure is not limited to this configuration.

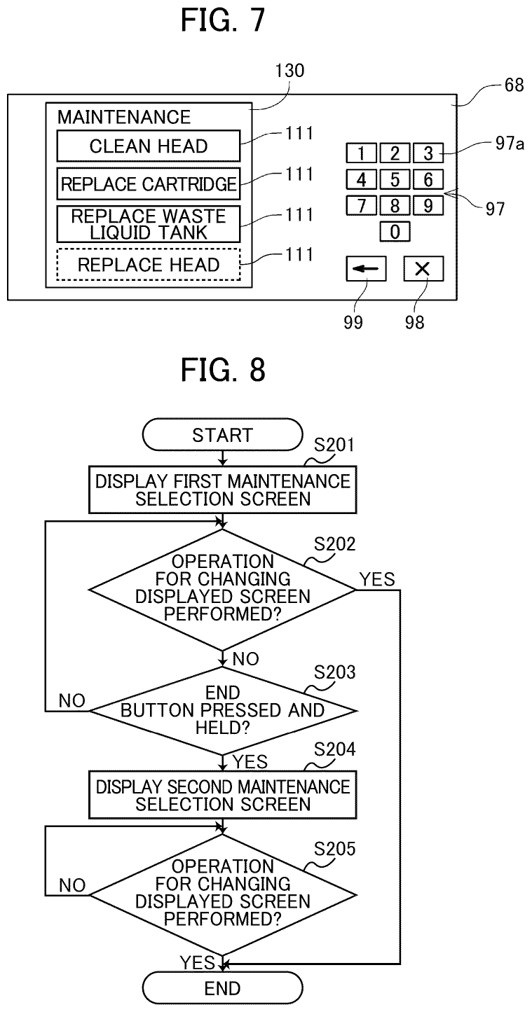

In a first modification, the controller 80 displays a first maintenance selection screen 130 illustrated in FIG. 7 on the operation panel 68 in S101 of the flowchart in FIG. 3B. The first maintenance selection screen 130 includes the selection buttons 111 which are the same as those included in the first maintenance selection screen 110A, as well as the “Replace head” selection button 111 which is the same as that included in the second maintenance selection screen 110B. However, the “Replace head” selection button 111 is grayed out in the first maintenance selection screen 130, indicating that the “Replace head” selection button 111 cannot be selected. In other words, the “Replace head” selection button 111 is displayed in the first maintenance selection screen 130 in a user-inoperable state. Note that the outer frame of the “Replace head” selection button 111 is depicted with a broken line in FIG. 7 to indicate that the “Replace head” selection button 111 has been grayed out.

As the second maintenance selection screen 110B, which includes the “Replace head” selection button 111 in a user-operable state, is displayed on the operation panel 68 in the first modification, the user can recognize that the “Replace head” selection button 111 can be selected to initiate replacement of the head 4. On the other hand, by displaying the first maintenance selection screen 130, which includes the “Replace head” selection button 111 in a user-inoperable state, on the operation panel 68, the user can be restricted from being misled into thinking that the “Replace head” selection button 111 can be selected to initiate replacement of the head 4.

While the first modification indicates that the “Replace head” selection button 111 cannot be selected by making the “Replace head” selection button 111 grayed out, the “Replace head” selection button 111 may be displayed in a different form to indicate that the “Replace head” selection button 111 cannot be selected. For example, a mark such as a lock or a cross may be displayed over the “Replace head” selection button 111 to indicate that the “Replace head” selection button 111 is user-inoperable.

In the above embodiment, the second maintenance selection screen 110B is displayed on the operation panel 68 when the back button 99 is pressed and held while the first maintenance selection screen 110A is displayed on the operation panel 68, but the method of switching displays is not limited to this method.

The flowchart in FIG. 8 illustrates a process according to a second modification that the controller 80 performs when the “Maintenance” selection button 101 is selected in the settings screen 100. The flowchart in FIG. 8 includes the process of S203 in place of the process of S103 in the flowchart of FIG. 3B. Note that the process of S201, S202, S204, and S205 are identical to those of S101, S102, S104, and S105 in the flowchart of FIG. 3B, respectively. In S203 the controller 80 determines whether the end button 98 has been pressed and held.

In other words, when the end button 98 is pressed and held while the first maintenance selection screen 110A is displayed on the operation panel 68 in the second modification (S203: YES), in S204 the controller 80 displays the second maintenance selection screen 110B on the operation panel 68.

In the second modification, when the first maintenance selection screen 110A, which does not contain the “Replace head” selection button 111, is displayed on the operation panel 68 and the user presses and holds the end button 98, which is displayed on the operation panel 68 and is not normally pressed and held, the controller 80 displays the second maintenance selection screen 110B, which contains the “Replace head” selection button 111, on the operation panel 68. In other words, when the end button 98, which is displayed on the operation panel 68 and is not normally pressed and held, is pressed and held while the operation panel 68 is operated in the replacement disabled mode, the controller 80 switches the operation mode of the operation panel 68 to the replacement enabled mode. This configuration can restrict the user from mistakenly placing the operation panel 68 in the replacement enabled mode so that the second maintenance selection screen 110B is displayed on the operation panel 68. In this modification, the end button 99 is an example of the claimed “specific button”.

In the embodiment described above, image recording is halted when the end button 98 is selected during the image recording, but the present disclosure is not limited to this configuration. Instead, separately from the end button 98, a Halt Recording button may be included in the printer 1 as a button for halting image recording. In this case, the controller 80 may display the second maintenance selection screen 110B on the operation panel 68 when the Halt Recording button is pressed and held while the first maintenance selection screen 110A is displayed on the operation panel 68.

The controller 80 may also be configured to display the second maintenance selection screen 110B on the operation panel 68 when a button other than the buttons described above is pressed and held while the first maintenance selection screen 110A is displayed on the operation panel 68.

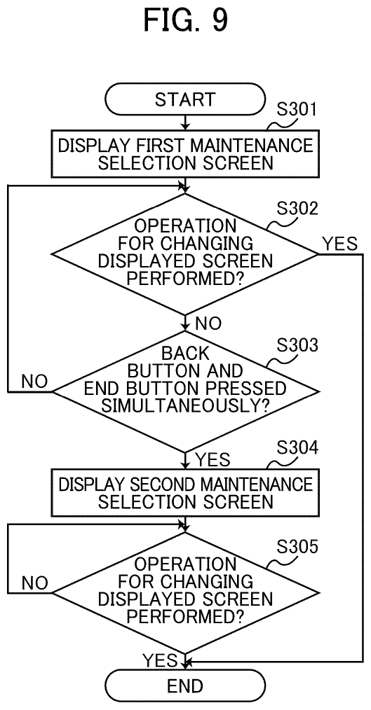

The flowchart in FIG. 9 illustrates a process according to a third modification that the controller 80 executes when the “Maintenance” selection button 101 is selected in the settings screen 100. The flowchart in FIG. 9 includes the process in S303 that replaces the process in S103 in the flowchart of FIG. 3B. Note that the process in S301, S302, S304, and S305 are identical to those in S101, S102, S104, and S105 in the flowchart of FIG. 3B, respectively. In S303 the controller 80 determines whether the back button 99 and the end button 98 are pressed simultaneously. Here, “the buttons are pressed simultaneously” denotes that the buttons are selected at the same time.

In other words, when the back button 99 and the end button 98 are pressed simultaneously while the first maintenance selection screen 110A is displayed on the operation panel 68 in the third modification (S303: YES), in S304 the controller 80 displays the second maintenance selection screen 110B on the operation panel 68.

In the third modification, when the first maintenance selection screen 110A, which does not contain the “Replace head” selection button 111, is displayed on the operation panel 68 and the user simultaneously selects the back button 99 and the end button 98, which are not normally operated at the same time, the controller 80 displays the second maintenance selection screen 110B, which contains the “Replace head” selection button 111, on the operation panel 68. In other words, when the back button 99 and the end button 98, which are not normally operated at the same time, are selected simultaneously while the operation panel 68 is operated in the replacement disabled mode, the controller 80 switches the operation mode of the operation panel 68 to the replacement enabled mode. This configuration restricts the user from mistakenly placing the operation panel 68 in the replacement enabled mode so that the second maintenance selection screen 110B is displayed on the operation panel 68.

Although the controller 80 determines in S303 whether the back button 99 and the end button 98 are pressed simultaneously in the third modification, the present disclosure is not limited to this configuration. For example, the controller 80 may determine in S303 of the third modification whether the back button 99 and a button other than the end button 98 among the plurality of buttons displayed on the operation panel 68 are pressed simultaneously. Alternatively, the controller 80 may determine in S303 of the third modification whether a button other than the back button 99 from among the plurality of buttons displayed on the operation panel 68 is pressed at the same time as the end button 98.

Alternatively, the controller 80 may determine in S303 of the third modification whether two buttons other than the back button 99 and the end button 98 among the plurality of buttons displayed on the operation panel 68 are pressed simultaneously. Still alternatively, the controller 80 may determine in S303 of the third modification whether three or more buttons among the plurality of buttons displayed on the operation panel 68 are pressed simultaneously.

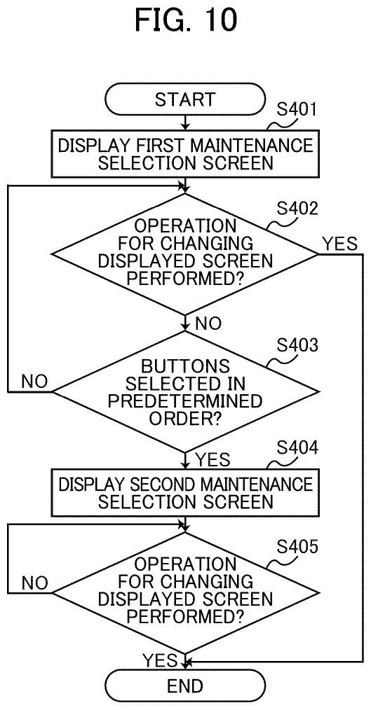

In a fourth modification, the controller 80 executes a process according to the flowchart in FIG. 10 when the “Maintenance” selection button 101 is selected in the settings screen 100. The flowchart in FIG. 10 includes the process of S403 that replaces the process of S103 in the flowchart of FIG. 3B, while the process of S401, S402, S404, and S405 are identical to those of S101, S102, S104, and S105 in the flowchart of FIG. 3B, respectively. In S403 the controller 80 determines whether two or more of the plurality of buttons displayed on the operation panel 68 are selected in a predetermined order.

In other words, in the fourth modification, when two or more predetermined buttons among the buttons displayed on the operation panel 68 are selected in the predetermined order while the first maintenance selection screen 110A is displayed on the operation panel 68 (S403: YES), in S404 the controller 80 displays the second maintenance selection screen 110B on the operation panel 68.

In the fourth modification, when the first maintenance selection screen 110A, which does not include the “Replace head” selection button 111, is displayed on the operation panel 68 and two or more buttons among the buttons displayed on the operation panel 68 are selected in a predetermined order not ordinarily used, the controller 80 displays the second maintenance selection screen 110B, which includes the “Replace head” selection button 111, on the operation panel 68. In other words, when the two or more buttons among the buttons displayed on the operation panel 68 are selected in the predetermined order not normally used while the operation panel 68 is operated in the replacement disabled mode, the controller 80 switches the operation mode of the operation panel 68 to the replacement enabled mode. This configuration can restrict the user from mistakenly placing the operation panel 68 in the replacement enabled mode, causing the second maintenance selection screen 110B to be displayed on the operation panel 68.

Further, the present disclosure need not be limited to a configuration in which the state of the display on the operation panel 68 is switched from the first maintenance selection screen 110A to the second maintenance selection screen 110B in response to user operations on the operation panel 68. For example, the controller 80 may cause the operation panel 68 to display the first maintenance selection screen 110A or the second display maintenance selection screen 110B on the display panel 68 in response to determining whether a predetermined condition related to the condition of the head 4 has been met.

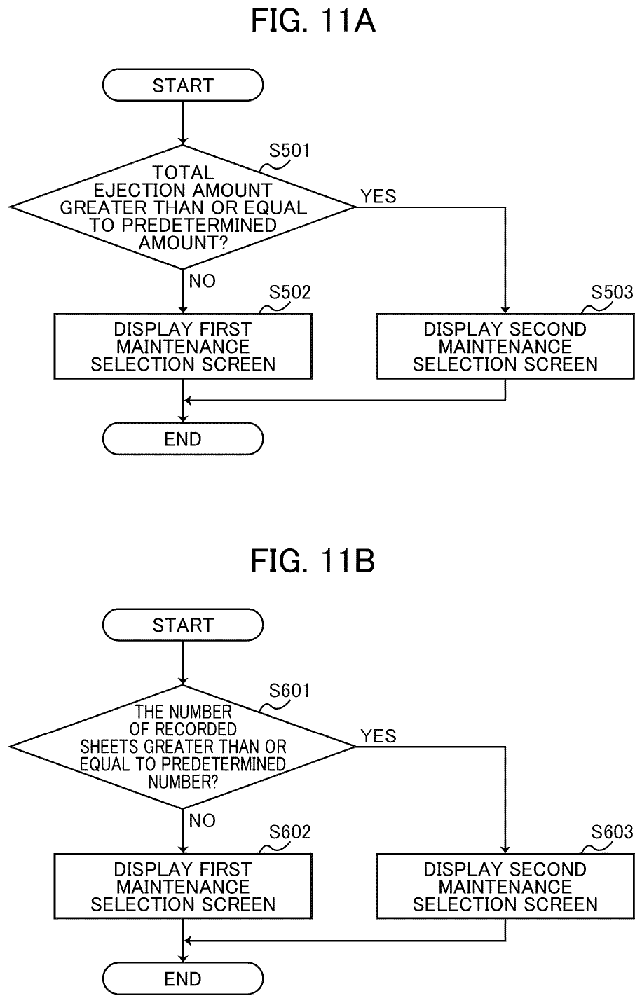

In a fifth modification, the controller 80 executes a process in accordance with the flowchart in FIG. 11A when the “Maintenance” selection button 101 is selected in the settings screen 100. More specifically, in S501 the controller 80 determines whether a total ejection amount is greater than or equal to a predetermined amount. The total ejection amount is a total amount of ink that has been ejected from the head 4. Here, the controller 80 keeps track of an amount of ink ejected through each of the nozzles 10 in the head 4 and stores the total ejection amount in the memory 84. The controller 80 performs the determination process in S501 on the basis of the total ejection amount stored in the memory 84. In the fifth modification, a condition that the total ejection amount is greater than or equal to the predetermined amount is an example of the claimed “predetermined condition”.

When the total ejection amount is less than the predetermined amount (S501: NO), in S502 the controller 80 displays the first maintenance selection screen 110A on the operation panel 68 and subsequently ends the process according to the flowchart of FIG. 11A. On the other hand, when the total ejection amount is greater than or equal to the predetermined amount (S501: YES), in S503 the controller 80 displays the second maintenance selection screen 110B on the operation panel 68 and subsequently ends the process according to the flowchart in FIG. 11A.

The necessity to replace the head 4 is low when the total ejection amount from the head 4 is low and is high when the total ejection amount is high.

Therefore, in the fifth modification, when the “Maintenance” selection button 101 is selected in the settings screen 100 and the total ejection amount from the head 4 is less than the predetermined amount, the controller 80 displays the first maintenance selection screen 110A on the operation panel 68. In other words, the operation panel 68 is operated in the replacement disabled mode. On the other hand, when the “Maintenance” selection button 101 is selected in the settings screen 100 and the total ejection amount from the head 4 is greater than or equal to the predetermined amount, the controller 80 displays the second maintenance selection screen 110B on the operation panel 68. Hence, the operation panel 68 is operated in the replacement enabled mode.

As a result, the user can select the “Replace head” selection button 111 when the necessity to replace the head 4 is high. Additionally, this configuration can restrict the user from selecting the “Replace head” selection button 111 when the necessity to replace the head 4 is low.

In a sixth modification, the controller 80 executes a process according to the flowchart in FIG. 11B when the “Maintenance” selection button 101 is selected in the settings screen 100. More specifically, in S601 the controller 80 determines whether the number of recoding sheets S on which image forming has been performed on the printer 1 since the printer 1 was first used or since the head 4 was last replaced is greater than or equal to a predetermined number. In this case, the controller 80 counts the number of recording sheets S on which image recording has been performed since the printer 1 was first used or since the head 4 was last replaced, and stores this count in the memory 84. The controller 80 performs the determination process in S601 on the basis of the number of recording sheets S that is stored in the memory 84. In the sixth modification, a condition that the number of recording sheets S described above is greater than or equal to the predetermined number is an example of the claimed “predetermined condition”.

When the number of recording sheets S described above is less than the predetermined number (S601: NO), in S602 the controller 80 displays the first maintenance selection screen 110A on the operation panel 68 and subsequently ends the process according to the flowchart in FIG. 11B. On the other hand, when the number of recording sheets S is greater than or equal to the predetermined number (S601: YES), in S603 the controller 80 displays the second maintenance selection screen 110B on the operation panel 68 and subsequently ends the process according to the flowchart in FIG. 11B.

The necessity to replace the head 4 is low when the number of recording sheets S recorded on the printer 1 is low and is high when the number of recording sheets S recorded on the printer 1 is high.

Therefore, when the “Maintenance” selection button 101 is selected in the settings screen 100 and the number of recording sheets S recorded on the printer 1 is less than the predetermined number in the sixth modification, the controller 80 displays the first maintenance selection screen 110A on the operation panel 68. In other words, the operation panel 68 operates in the replacement disabled mode. On the other hand, when the “Maintenance” selection button 101 is selected in the settings screen 100 and the number of recording sheets S recorded on the printer 1 is greater than or equal to the predetermined number, the controller 80 displays the second maintenance selection screen 110B on the operation panel 68. That is, the operation panel 68 operates in the replacement enabled mode. In this way, the user can select the “Replace head” selection button 111 when the necessity to replace the head 4 is high. Further, the above configuration can restrict the user from selecting the “Replace head” selection button 111 when the necessity to replace the head 4 is low.

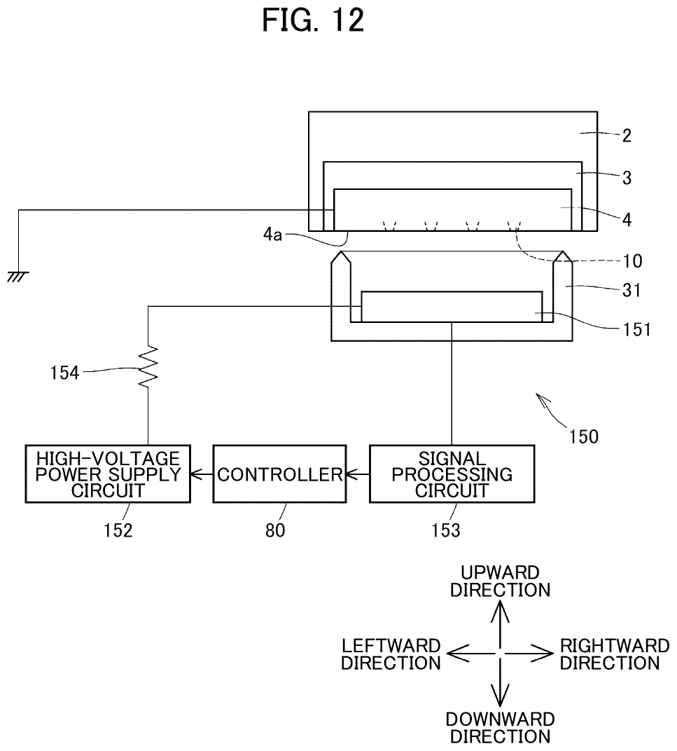

In a seventh modification, the purge unit 8 also includes an ejection inspection unit 150, as illustrated in FIG. 12. The ejection inspection unit 150 includes an electrode 151, a high-voltage power supply circuit 152, a signal processing circuit 153, and a resistor 154. The ejection inspection unit 150 is an example of the claimed “sensor”.

The electrode 151 has a flat rectangular shape. The electrode 151 is disposed inside the cap 31 and is connected to the high-voltage power supply circuit 152 via the signal processing circuit 153. The high-voltage power supply circuit 152 is configured to apply a predetermined voltage of approximately 600 V, for example, to the electrode 151 under control of the controller 80. At the same time, the head 4 is maintained at ground potential, whereby a potential difference is produced between the head 4 and the electrode 151. The signal processing circuit 153 is connected to the electrode 151. The signal processing circuit 153 includes a differential circuit, for example, and is configured to output a signal corresponding to the voltage of the electrode 151 to the controller 80. In the seventh modification, the signal outputted from the signal processing circuit 153 is a voltage signal. However, the signal outputted from the signal processing circuit 153 may be a current signal.

In the seventh modification, with the nozzles 10 in the capped state and the high-voltage power supply circuit 152 applying voltage to the electrode 151, an ejection drive can be performed in which each of the nozzles 10 in the head 4 is driven to cause ink to be ejected through the nozzles 10 toward the electrode 151.

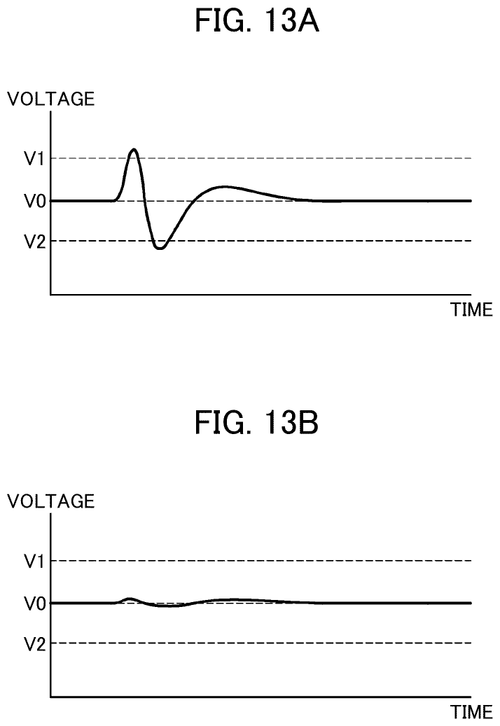

Here, in a state where the nozzles 10 are in the capped state, the high-voltage power supply circuit 152 applies the predetermined voltage to the electrode 151, and the ejection drive is not performed, the voltage of the signal outputted from the signal processing circuit 153 is approximately V0, as illustrated in FIGS. 13A and 13B.

When ink is ejected through the nozzles 10 in the ejection drive, the ejected ink is charged due to the potential difference between the electrode 151 and the head 4. As the charged ink approaches the electrode 151, the potential of the electrode 151 changes until the ink impacts the electrode 151. After the charged ink impacts the electrode 151, the potential of the electrode 151 attenuates and returns to the potential prior to ink ejection.

Accordingly, when ink is normally ejected through a nozzle 10 during an ejection drive, as illustrated in FIG. 13A, the signal outputted from the signal processing circuit 153 rises from the voltage V0 to at least a voltage V1 that is higher than the voltage V0, then decreases to at least a voltage V2 that is lower than the voltage V0, and thereafter repeatedly rises and falls while attenuating until returning to the voltage V0.

However, if any abnormality presents in a nozzle 10 such that an amount of ink ejected through the nozzle 10 in the ejection drive is less than normal, the signal outputted from the signal processing circuit 153 changes less than when ink is normally ejected through the nozzle 10, as illustrated in FIG. 13B. Here, cases in which an amount of ejected ink is less than when ink is ejected normally through the nozzle 10 include cases in which no ink is ejected through the nozzle 10. When ink is not ejected through a nozzle 10 in the ejection drive, the signal outputted from the signal processing circuit 153 changes very little from the voltage V0.

Thus, the signal outputted from the signal processing circuit 153 in the seventh modification differs depending on whether ink is ejected normally through the nozzle 10 during the ejection drive. In other words, the signal outputted from the signal processing circuit 153 indicates whether the nozzle 10 is a normal nozzle through which ink is ejected normally or an abnormal nozzle through which ink is ejected irregularly. In the seventh modification, whether the nozzle 10 is a normal nozzle or an abnormal nozzle is an example of the claimed “ejection state of ink through the nozzle”.

In the seventh modification, the controller 80 causes an ejection drive to be performed for each of the plurality of nozzles 10 in the head 4 at appropriate timings to cause the ejection inspection unit 150 to sense whether each nozzle 10 is a normal nozzle or an abnormal nozzle on the basis of the signal outputted from the signal processing circuit 153. As the above sensing is performed in the seventh modification, information indicating whether each nozzle 10 is a normal nozzle or an abnormal nozzle is stored in the memory 84.

In the seventh modification, the predetermined voltage is applied to the electrode 151, the head 4 is maintained at ground potential, and the signal processing circuit 153 is configured to output a signal corresponding to the voltage of the electrode 151. However, a configuration different from that described above may be employed. For example, a potential difference between the electrode 151 and the head 4 may be generated by maintaining the electrode 151 at ground potential and applying a predetermined voltage to the head 4. In this case, the signal processing circuit 153 is connected to the head 4 and is configured to output a signal corresponding to the voltage of the head 4 when an ejection drive is performed.

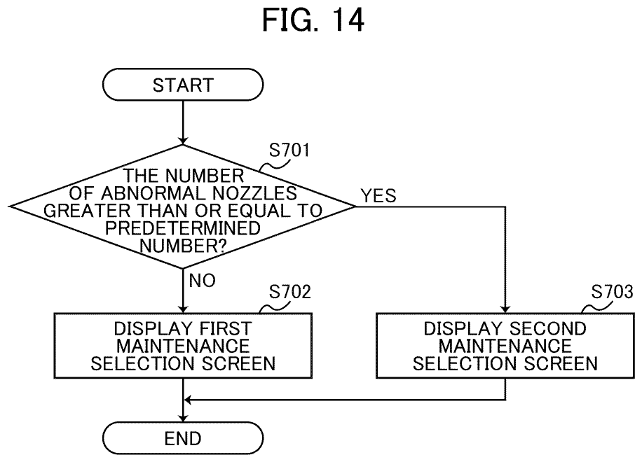

In the seventh modification, the controller 80 performs a process in accordance with the flowchart of FIG. 14 when the “Maintenance” selection button 101 is selected in the settings screen 100. Specifically, in S701 the controller 80 determines whether the number of abnormal nozzles is greater than or equal to a predetermined number. The controller 80 performs the determination process in S701 on the basis of the information stored in the memory 84 that indicates whether each nozzle 10 is a normal nozzle or an abnormal nozzle. In the seventh modification, a condition that the number of abnormal nozzles is greater than or equal to the predetermined number is an example of the claimed “predetermined condition”.

When the number of abnormal nozzles is less than the predetermined number (S701: NO), in S702 the controller 80 displays the first maintenance selection screen 110A on the operation panel 68 and subsequently ends the process according to the flowchart in FIG. 14.

When the number of abnormal nozzles is greater than or equal to the predetermined number (S701: YES), in S703 the controller 80 displays the second maintenance selection screen 110B on the operation panel 68 and subsequently ends the process according to the flowchart of FIG. 14.

The necessity to replace the head 4 is low when the number of abnormal nozzles in the head 4 is small and is high when the number of abnormal nozzles in the head 4 is large.

Therefore, when the “Maintenance” selection button 101 is selected in the settings screen 100 and the number of abnormal nozzles in the head 4 is less than the predetermined number in the seventh modification, the controller 80 displays the first maintenance selection screen 110A on the operation panel 68. In other words, the operation panel 68 is operated in the replacement disabled mode. On the other hand, when the “Maintenance” selection button 101 is selected in the settings screen 100 and the number of abnormal nozzles in the head 4 is greater than or equal to the predetermined number, the controller 80 displays the second maintenance selection screen 110B on the operation panel 68. In other words, the operation panel 68 is operated in the replacement enabled mode. In this way, the user can select the “Replace head” selection button 111 when the necessity to replace the head 4 is high. Further, the user can be restricted from selecting the “Replace head” selection button 111 when the necessity to replace the head 4 is low.

In the seventh modification, the printer 1 includes the ejection inspection unit 150 and obtains information indicating whether each nozzle 10 is a normal nozzle or an abnormal nozzle on the basis of the above inspection results using the ejection inspection unit 150. However, the present disclosure need not be limited to this configuration. For example, the printer 1 may record an inspection pattern with which the determination can be made as to whether ink has been ejected normally through each nozzle 10 as a result of visual recognition. In this case, by having the user input information on the basis of the recording results of the inspection pattern, the printer 1 can obtain information indicating whether each nozzle 10 is a normal nozzle or an abnormal nozzle. Alternatively, if the printer is a multifunction peripheral that includes a scanner, the multifunction peripheral may read the inspection pattern with the scanner and obtain information indicating whether each nozzle 10 is a normal nozzle or an abnormal nozzle on the basis of the scanning results. In these cases, the printer need not include an ejection inspection unit.

When the “Maintenance” selection button 101 is selected in the settings screen 100 in the seventh modification, the controller 80 displays one of the first maintenance selection screen 110A and the second maintenance selection screen 110B on the operation panel 68 on the basis of whether the number of abnormal nozzles is greater than or equal to the predetermined number, but a different configuration may be employed. For example, the controller 80 may display one of the first maintenance selection screen 110A and the second maintenance selection screen 110B on the operation panel 68 when the “Maintenance” selection button 101 is selected in the settings screen 100 on the basis of whether another condition has been met. The other condition is related to the information specifying whether each nozzle 10 is a normal nozzle or an abnormal nozzle.

In the seventh modification, the controller 80 stores information, in the memory 84, that indicates whether a nozzle 10 is a normal nozzle or an abnormal nozzle on the basis of the amount of ink ejected through the nozzle 10. However, the controller 80 may store information in the memory 84 indicating whether a nozzle 10 is a normal nozzle or an abnormal nozzle on the basis of another condition related to ink ejection that is different from the amount of ejected ink, for example, a direction in which ink is ejected through the nozzle 10.

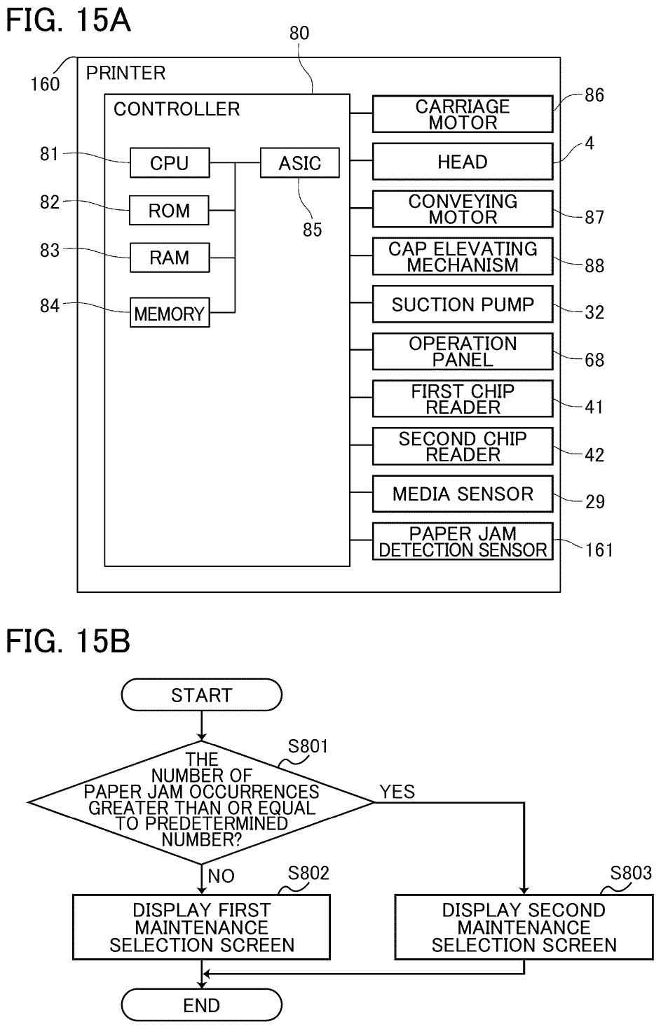

In an eighth modification illustrated in FIG. 15A, a printer 160 includes a paper jam detection sensor 161 in addition to the components included in the printer 1 according to the above embodiment. The paper jam detection sensor 161 functions to detect whether recording sheets S have become jammed during the image recording. For example, the paper jam detection sensor 161 is disposed on a conveying path along which recording sheets S are conveyed by the conveying rollers 6 and 7. The paper jam detection sensor 161 is configured to detect presence or absence of recording sheets S on the conveying path. The controller 80 can determine that a recording sheet S has become jammed when the paper jam detection sensor 161 does not detect the recording sheet S at a timing when the recording sheet S is normally detected if a paper jam has not occurred. The paper jam detection sensor 161 is an example of the claimed “detector”.

On the basis of the detection results by the paper jam detection sensor 161, the controller 80 stores information in the memory 84 indicating the number of paper jams that have occurred since the printer 160 was first used or the head 4 was last replaced.

When the “Maintenance” selection button 101 is selected in the settings screen 100 in the eighth modification, the controller 80 performs a process in accordance with the flowchart in FIG. 15B. Specifically, in S801 the controller 80 determines whether the number of paper jams that have occurred, which is stored in the memory 84, is greater than or equal to a predetermined number. In the eighth modification, a condition that the number of paper jam occurrences is greater than or equal to the predetermined number is an example of the claimed “predetermined condition”. The number of paper jam occurrences is an example of the claimed “detection history of the detector”.

When the number of paper jam occurrences is less than the predetermined number (S801: NO), in S802 the controller 80 displays the first maintenance selection screen 110A on the operation panel 68 and subsequently ends the process according to the flowchart of FIG. 15B. When the number of paper jam occurrences is greater than or equal to the predetermined number (S801: YES), in S803 the controller 80 displays the second maintenance selection screen 110B on the operation panel 68 and subsequently ends the process according to the flowchart of FIG. 15B.

In the event of a paper jam, there is a possibility that a recording sheet S contacts the head 4 to cause damage to the nozzles 10. Therefore, if a paper jam has not occurred or if the number of paper jam occurrences is low, the necessity to replace the head 4 is low. On the other hand, if paper jams have occurred numerous times, the necessity to replace the head 4 may be high.

Therefore, when the “Maintenance” selection button 101 is selected in the settings screen 100 and the number of paper jams that have occurred is less than the predetermined number in the eighth modification, the controller 80 displays the first maintenance selection screen 110A on the operation panel 68. In other words, the operation panel 68 is operated in the replacement disabled mode. On the other hand, when the “Maintenance” selection button 101 is selected in the settings screen 100 and the number of paper jam occurrences is greater than or equal to the predetermined number, the controller 80 displays the second maintenance selection screen 110B on the operation panel 68. That is, the operation panel 68 is operated in the replacement enabled mode. As a result, the user can select the “Replace head” selection button 111 when the necessity to replace the head 4 is high. Additionally, the user can be restricted from selecting the “Replace head” selection button 111 when the necessity to replace the head 4 is low.

When the “Maintenance” selection button 101 is selected in the settings screen 100 in the eighth modification, the controller 80 displays one of the first maintenance selection screen 110A and the second maintenance selection screen 110B on the operation panel 68 on the basis of whether the number of paper jam occurrences is greater than or equal to the predetermined number. However, further modifications may be made to the above configuration.

When the “Maintenance” selection button 101 is selected in the settings screen 100, the controller 80 may display one of the first maintenance selection screen 110A and the second maintenance selection screen 110B on the operation panel 68 on the basis of whether a different condition related to the occurrence of paper jams is met. For example, the controller 80 may display one of the first maintenance selection screen 110A and the second maintenance selection screen 110B on the operation panel 68 on the basis of the type of recording sheets S that have caused the paper jam. Alternatively, the controller 80 may display one of the first maintenance selection screen 110A and the second maintenance selection screen 110B on the operation panel 68 according to whether the paper jam occurred during the conveying operation or during the recording pass.

Alternatively, the controller 80 may display one of the first maintenance selection screen 110A and the second maintenance selection screen 110B on the operation panel 68 when the “Maintenance” selection button 101 is selected in the settings screen 100 on the basis of whether another predetermined condition has been met. Here, the other predetermined condition is related to the condition of the head 4 and different from the conditions described in the fifth through eighth modifications.

In the above examples, all buttons are displayed on the operation panel 68, but the present disclosure need not be limited to this configuration.

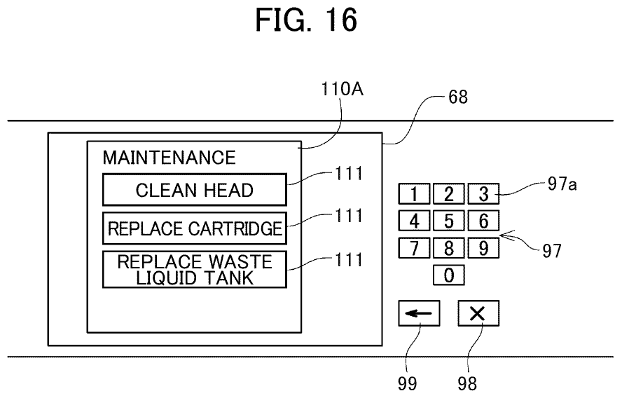

In a ninth modification illustrated in FIG. 16, the back button 99, the end button 98, and the numeric buttons 97a of the numeric keypad 97, which are constantly displayed on the operation panel 68 in the above embodiment and modifications, are physical buttons disposed on a housing of the printer 1. When the back button 99, which is a physical button in this modification and is not normally pressed and held, is pressed and held while the first maintenance selection screen 110A is displayed on the operation panel 68, the controller 80 displays the second maintenance selection screen 110B on the operation panel 68. In a case where a physical button is employed, “the back button 99 is pressed and held” denotes that the back button 99 is continuously in a pressed state for at least a predetermined period of time. While various screens are displayed on the operation panel 68 in the examples described above, FIG. 16 illustrates the first maintenance selection screen 110A displayed on the operation panel 68 as an example.

When the back button 99, which is a physical button and is normally not pressed and held, is pressed and held while the first maintenance selection screen 110A, which does not include the “Replace head” selection button 111, is displayed on the operation panel 68 in the ninth modification, the controller 80 displays the second maintenance selection screen 110B, which includes the “Replace head” selection button 111, on the operation panel 68. In other words, when the back button 99, which is a physical button and is normally not pressed and held, is pressed and held while the operation panel 68 is operated in the replacement disabled mode, the controller 80 switches the operation mode of the operation panel 68 to the replacement enabled mode. This configuration can restrict the user from accidentally placing the operation panel 68 in the replacement enabled mode, causing the second maintenance selection screen 110B to be displayed on the operation panel 68.

The buttons displayed on the operation panel 68, such as the selection buttons 101 in the settings screen 100 and the selection buttons 111 in the first and second maintenance selection screens 110A and 110B are also not limited to buttons that are selected by touching the area of the operation panel 68 in which the button is displayed. For example, the printer may include physical buttons that can be operated to select buttons displayed on the operation panel 68.

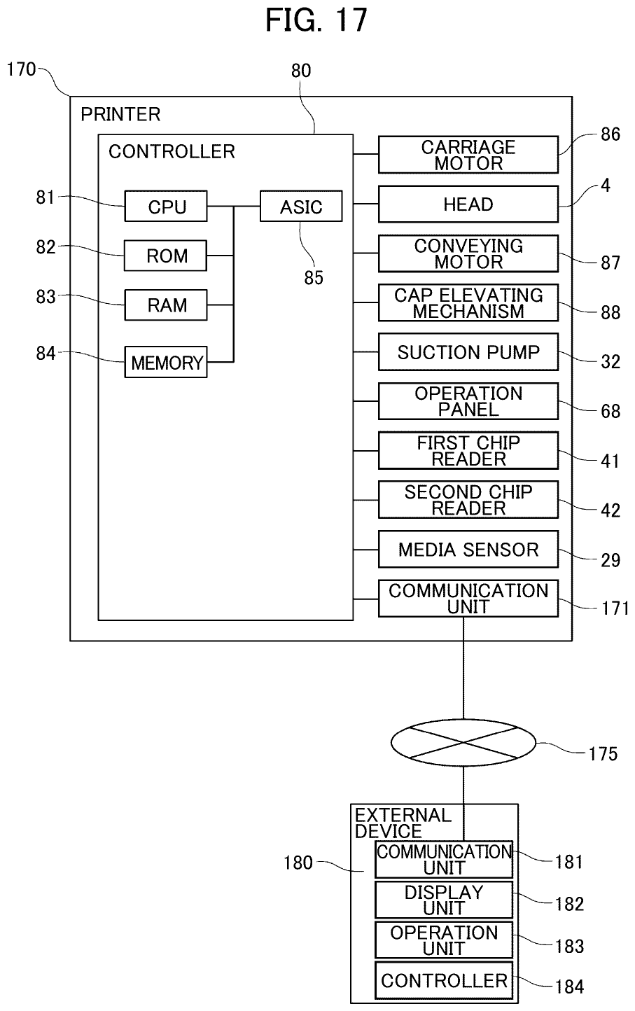

The operation panel 68 of the printer can be made to operate in the replacement enabled mode or the replacement disabled mode in response to operations on an external device connected to the printer. As illustrated in FIG. 17, a tenth modification relates to a system that includes a printer 170 and an external device 180. The printer 170 includes a communication unit 171 in addition to the configurations included in the printer 1 according to the embodiment described above. The communication unit 171 is connected to a network 175, such as a LAN. “LAN” is an abbreviation of “local area network”. Here, the communication unit 171 may be connected to the network 175 by a cable or may be connected to the network 175 via a wireless communication.

The external device 180 is a PC or a smartphone, for example. The external device 180 includes a communication unit 181, a display unit 182, an operation unit 183, and a controller 184. The communication unit 181 is connected to the network 175. Here, the communication unit 181 may be connected to the network 175 with a cable or may be connected to the network 175 wirelessly. The communication unit 181 is an example of the claimed “communication interface”. The operation unit 183 is an example of the claimed “user interface”.

In the tenth modification, the printer 170 and the external device 180 are connected to each other via the network 175 to communicate with each other. Note that the printer 170 and the external device 180 may be connected directly to each other with a cable or wirelessly. In this case, the printer 170 and the external device 180 need not be connected to the network 175.

The display unit 182 is a liquid crystal display, for example. The operation unit 183 includes parts of the external device 180 that the user operates such as a keyboard and a mouse when the external device 180 is a PC, or a touchscreen integrally formed with the display unit 182 when the external device 180 is a smartphone. That is, the operation unit 183 serves as a user interface that is operable by a user. The controller 184 includes a CPU, a ROM, a RAM, a memory, for example. The controller 184 is configured to control both operations of the external device 180 and operations of the printer 170.

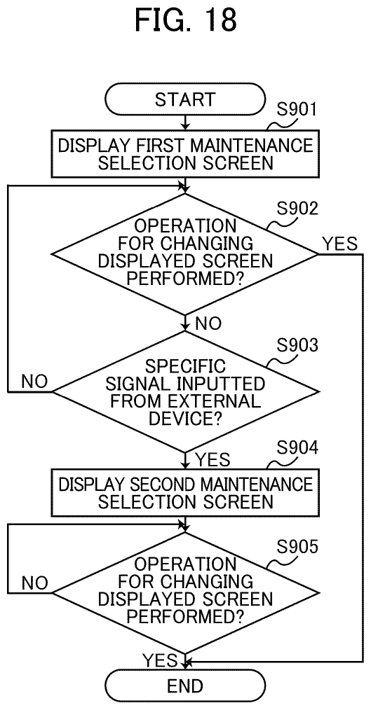

When the “Maintenance” selection button 101 is selected in the settings screen 100 in the tenth modification, the controller 80 executes a process in accordance with the flowchart of FIG. 18. The flowchart in FIG. 18 includes the process of S903 in place of the process of S103 in the flowchart of FIG. 3B, while the process of S901, S902, S904, and S905 are identical to those of S101, S102, S104, and S105 in the flowchart of FIG. 3B, respectively. In S903 the controller 80 determines whether a specific signal is inputted from the external device 180. The external device 180 transmits the specific signal to the printer 170 when a specific operation is performed on the operation unit 183 of the external device 180.

Accordingly, when the specific signal is inputted into the printer 170 from the external device 180 while the first maintenance selection screen 110A is displayed on the operation panel 68 in the tenth modification (S903: YES), in S904 the controller 80 displays the second maintenance selection screen 110B on the operation panel 68.

In the tenth modification, when the specific signal is received from the external device 180 while the first maintenance selection screen 110A, which does not include the “Replace head” selection button 111, is displayed on the operation panel 68, the controller 80 displays the second maintenance selection screen 110B, which includes the “Replace head” selection button 111, on the operation panel 68. In other words, in response to receiving the specific signal from the external device 180 while the operation panel 68 operates in the replacement disabled mode, the controller 80 switches the operation mode of the operation panel 68 to the replacement enabled mode. This configuration can restrict the user from inadvertently placing the operation panel 68 in the replacement enabled mode, causing the second maintenance selection screen 110B to be displayed on the operation panel 68.

In the above examples, the operation panel 68 of the printer is operated in the replacement enabled mode that enables the user to perform a replacement initiation operation for initiating replacement of the head 4, and the replacement disabled mode that restricts the replacement initiation operation. However, the present disclosure need not be limited to this configuration.

As with the tenth modification, an eleventh modification relates to a system including the printer 170 and the external device 180, as illustrated in FIG. 17.

In the eleventh modification, when the user of the external device 180 performs a predetermined operation on the operation unit 183, the controller 184 displays the same settings screen 100 illustrated in FIG. 3A on the display unit 182.

When the “Maintenance” selection button 101 is selected by the user through an operation on the operation unit 183, the controller 184 performs the process according to the flowchart of FIG. 3B. As a result, the controller 184 can switch the operation mode of the operation unit 183 to the replacement disabled mode in which an operation of selecting the “Replace head” selection button 111 is disabled by displaying on the display unit 182 the first maintenance selection screen 110A, which does not include the “Replace head” selection button 111. The controller 184 can also shift the operation mode of the operation unit 183 to the replacement enabled mode in which an operation of selecting the “Replace head” selection button 111 is enabled by displaying on the display unit 182 the second maintenance selection screen 110B, which includes the “Replace head” selection button 111.

As in the description of the above embodiment, the controller 184 in the eleventh modification can display the same cartridge replacement screen 121 illustrated in FIG. 5A, the same tank replacement screen 122 illustrated in FIG. 5B, and the same head replacement screen 123 illustrated in FIG. 6A on the display unit 182 when the corresponding selection button 111 is selected in the first and second maintenance selection screens 110A and 110B. The controller 184 can also display the same head information entry screen 124 illustrated in FIG. 6B on the display unit 182 when the Completed button 123B is selected in the head replacement screen 123.

Further, when any of the selection buttons 111 is selected in the first and second maintenance selection screens 110A and 110B in the eleventh modification, the controller 184 transmits signals to the printer 170 via the network 175 that control the printer 170 to perform operations corresponding to the selected selection button 111. The controller 80 of the printer 170 then performs operations on the basis of the signals received from the controller 184.

Further, when the user selects the Completed button 124C in the head information entry screen 124 after inputting the head parameters, the media sensor parameters, and the serial number, as described in the above embodiment, the controller 184 transmits information on the head parameters, the media sensor parameters, and the serial number for the new head 4 to the printer 170 via the network 175. The controller 80 of the printer 170 then configures the printer 170 on the basis of the information received from the controller 184.

In the eleventh modification, the operation mode of the operation unit 183 in the external device 180 is set to the replacement enabled mode, which enables the user to select the “Replace head” selection button 111, by displaying the second maintenance selection screen 110B on the display unit 182 and to the replacement disabled mode in which the “Replace head” selection button 111 cannot be selected by displaying the first maintenance selection screen 110A on the display unit 182. This configuration enables the “Replace head” selection button 111 to be selected on the operation unit 183 only when replacement of the head 4 is appropriate.

In the embodiment described above, each of the ink cartridges 24 includes the IC chip 26. The controller 80 can detect whether the ink cartridge 24 has been replaced by obtaining information from the corresponding IC chip 26. Also, the waste liquid tank 33 includes the IC chip 34. The controller 80 can detect whether the waste liquid tank 33 has been replaced by obtaining information from the IC chip 34. However, the present disclosure is not limited to this configuration.

For example, each of the cartridge attachment portions 23 may include a residual quantity sensor for detecting the residual quantity of ink in the corresponding one of the ink cartridges 24. In this case, the controller 80 may detect that the ink cartridge 24 has been replaced when the residual quantity of ink detected by the corresponding residual quantity sensor changes from a quantity less than a predetermined quantity to a quantity greater than or equal to the predetermined quantity. In this case, the ink cartridges 24 need not include the IC chips 26.

The waste liquid tank 33 may also include a stored quantity sensor for detecting the quantity of waste liquid stored in the waste liquid tank 33. In this case, the controller 80 may detect that the waste liquid tank 33 has been replaced when the stored quantity of waste liquid detected by the stored quantity sensor changes from a quantity greater than or equal to a predetermined stored quantity to a quantity less than the predetermined stored quantity. The waste liquid tank 33 need not include the IC chip 34 in this case.

In the examples described above, the replaceable components in the printer are divided into two categories: replaceable components for which a replacement initiation operation is disabled while the operation unit is operated in the replacement disabled mode, and second replaceable components for which a replacement initiation operation is enabled irrespective of whether the operation unit is operated in the replacement enabled mode or in the replacement disabled mode.

In the above examples, the head 4, whose replacement cannot be detected, serves as a first replaceable component while the ink cartridges 24 and the waste liquid tank 33, whose replacements can be detected, serve as second replaceable components. However, the present disclosure is not limited to this configuration. Replaceable components may be classified as first replaceable components or second replaceable components regardless of whether their replacement can be detected.

In the examples described above, the head 4, for which the operation panel 68 prompts the user to enter an input when replaced, serves as an example of a first replaceable component while the ink cartridges 24 and the waste liquid tank 33, for which the operation panel 68 does not prompt the user to enter an input when replaced, serve as examples of second replaceable components, but the present disclosure is not limited to this arrangement. Replaceable components may be classified as first replaceable components or second replaceable components regardless of whether user input is prompted upon their replacement.

The above examples describe cases in which the head, the ink cartridges, and the waste liquid tank of the printer are replaceable components, but the present disclosure is not limited to this arrangement. Components of the printer other than the head, the ink cartridges, and the waste liquid tank may be replaceable components.

In the above examples, replacement components of the printer are classified as either first replaceable components or second replaceable components, but the present disclosure is not limited to this arrangement. For all replaceable components in the printer, the user may be allowed to perform an operation on the operation unit to initiate the replacement of each replaceable component while the operation unit operates in the replacement enabled mode, and may be restricted from performing operations to initiate such replacements while the operation unit operates in the replacement disabled mode.

As an example, the selection buttons 111 in the first maintenance selection screen 110A may not include the selection buttons 111 for “Replace cartridge”, “Replace waste liquid tank”, and “Replace head” which are described in the above examples. In this case, when the back button 99 is pressed and held while the first maintenance selection screen 110A is displayed on the operation panel 68, the controller 80 may display the second maintenance selection screen 110B, which includes the selection buttons 111 for “Replace cartridge”, “Replace waste liquid tank”, and “Replace head”, on the operation panel 68, as in the above examples.

In the embodiment described above, the controller 80 switches the screen displayed on the operation panel 68 from the second maintenance selection screen 110B to a different screen, and subsequently displays the first maintenance selection screen 110A on the operation panel 68 when the “Maintenance” selection button 101 is selected in the settings screen 100. However, the present disclosure is not limited to this configuration. For example, when the controller 80 switches the screen displayed on the operation panel 68 from the second maintenance selection screen 110B to a different screen and the “Maintenance” selection button 101 has been subsequently selected in the settings screen 100, the controller 80 may display the second maintenance selection screen 110B again on the operation panel 68.

In this case, when a specific operation such as the back button 99 being pressed and held is performed while the second maintenance selection screen 110B is displayed on the operation panel 68, the controller 80 may switch the screen displayed on the operation panel 68 from the second maintenance selection screen 110B to the first maintenance selection screen 110A.

The above description provides examples in which the present disclosure is applied to an inkjet printer including a so-called serial head which is configured to eject ink through a plurality of nozzles while moving in the leftward and rightward directions together with a carriage. However, the present disclosure may be applied to other types of printers. For example, the present disclosure may be applied to an inkjet printer including a so-called line head that extends across the entire length of the platen 5 in the leftward and rightward directions. The present disclosure may also be applied to a laser printer which includes toner cartridges as the replaceable components and is configured to records images by depositing toner from the toner cartridges on recording papers. Further, instead of image recording devices configured to record images on recording papers, the present disclosure may be applied to other devices including replaceable components.

The term “controller” encompasses both a single controller or a group of multiple controllers located either locally or remotely working together or in a distributed fashion to collectively perform the tasks attributed to the “controller” described herein.

What is claimed is:

1. A device comprising:
a replaceable component;
a user interface operable by a user; and
a controller configured to:
cause the user interface to operate in both:
a replacement enabled mode in which a replacement initiation operation on the user interface is enabled, the replacement initiation operation being an operation for initiating replacement of the replaceable component; and
a replacement disabled mode in which the replacement initiation operation on the user interface is disabled.

2. The device according to claim 1,
wherein the user interface includes an operation panel,
wherein, while the user interface operates in the replacement enabled mode, the controller displays a replacement initiation button on the operation panel, the replacement initiation button being a button through which the replacement initiation operation is performed, and
wherein, while the user interface operates in the replacement disabled mode, the controller does not display the replacement initiation button on the operation panel.

3. The device according to claim 1,
wherein the user interface includes an operation panel,
wherein, while the user interface operates in the replacement enabled mode, the controller displays a replacement initiation button in a user-operable state on the operation panel, the replacement initiation button being a button through which the replacement initiation operation is performed, and
wherein, while the user interface operates in the replacement disabled mode, the controller displays the replacement initiation button in a user-inoperable state on the operation panel.

4. The device according to claim 1,
wherein the user interface includes a specific button, and
wherein, when the specific button is pressed and held while the user interface operates in the replacement disabled mode, the controller switches an operation mode of the user interface to the replacement enabled mode.

5. The device according to claim 4,
wherein the device is an image recording device, and
wherein the specific button is a button configured to be pressed for halting image recording started by the image recording device on a recording medium.

6. The device according to claim 4,
wherein the user interface includes a display, and
wherein the specific button is a button configured to pressed for ending display of a current screen on the display or a button configured to be pressed for ending display of the current screen on the display and displaying a previous screen on the display, the previous screen being a screen displayed on the display immediately before the current screen.

7. The device according to claim 4,
wherein the specific button is a physical button.

8. The device according to claim 4,
wherein the user interface includes an operation panel configured to display the specific button.

9. The device according to claim 1, further comprising:
a second replaceable component different from the replaceable component,
wherein a second replacement initiation operation on the user interface is enabled regardless of whether the user interface operates in the replacement enabled mode or in the replacement disabled mode, the second replacement initiation operation being an operation for initiating replacement of the second replaceable component.

10. The device according to claim 9,
wherein, when the replacement of the replaceable component is completed, the controller causes the user interface to prompt the user for input through the user interface, and
wherein, when the replacement of the second replaceable component is completed, the controller does not cause the user interface to prompt the user for input through the user interface.

11. The device according to claim 9,
wherein the device is an image recording device comprising:
a head including a nozzle, the head being configured to eject ink through the nozzle;
an ink cartridge storing ink to be supplied to the head; and
a waste liquid tank configured to store ink that has been ejected through the nozzle,
wherein the head is the replaceable component, and
wherein at least one of the ink cartridge or the waste liquid tank is the second replaceable component.

12. The device according to claim 9,
wherein the controller does not detect completion of the replacement of replaceable component but detects completion of the replacement of the second replaceable component.

13. The device according to claim 12,
wherein the replaceable component includes no IC chip, and
wherein the second replaceable component includes an IC chip storing information related to the second replaceable component,
the device further comprising:
a reader configured to read the information stored in the IC chip,
wherein the controller detects the completion of the replacement of the second replaceable component based on the information read from the IC chip through the reader.

14. The device according to claim 1,
wherein the device is configured to communicate with an external device, and
wherein, in response to receiving a specific signal from the external device while the user interface operates in the replacement disabled mode, the controller switches an operation mode of the user interface to the replacement enabled mode.

15. The device according to claim 1,
wherein the device is an image recording device comprising:
a head including a nozzle, the head being configured to eject ink through the nozzle,
wherein the head is the replaceable component,
wherein, in a state where a predetermined condition regarding a condition of the head is not met, the controller causes the user interface to operate in the replacement disabled mode, and
wherein, in a state where the predetermined condition is met, the controller causes the user interface to operate in the replacement enabled mode.

16. The device according to claim 15,
wherein the predetermined condition is met when a total amount of ink that has been ejected through the nozzle is greater than or equal to a predetermined amount.

17. The device according to claim 15,
wherein the predetermined condition is met when the number of recording media on which image recording has been performed by the head is greater than or equal to a predetermined number.

18. The device according to claim 15, further comprising:
a sensor configured to sense an ejection state of ink through the nozzle,
wherein the predetermined condition is related to the ejection state of the ink sensed by the sensor.

19. The device according to claim 1, further comprising:
a detector configured to detect a recording medium jam,
wherein, in a state where a predetermined condition regarding a detection history of the detector is not met, the controller causes the user interface to operate in the replacement disabled mode, and
wherein, in a state where the predetermined condition is met, the controller causes the user interface to operate in the replacement enabled mode.

20. The device according to claim 1,
wherein the user interface includes a plurality of operation buttons, and
wherein, when two or more of the plurality of operation buttons are operated in a predetermined order while the user interface operates in the replacement disabled mode or when two or more of the plurality of operation buttons are simultaneously operated while the user interface operates in the replacement disabled mode, the controller switches an operation mode of the user interface to the replacement enabled mode.

21. The device according to claim 1,
wherein the user interface includes an operation panel,
wherein, when the user interface operates in the replacement enabled mode, the controller causes the operation panel to display a first screen enabling the replacement initiation operation to be performed, and
wherein, when a screen displayed on the operation panel is switched from the first screen to a second screen different from the first screen, the controller causes the user interface to operate in the replacement disabled mode.

22. An external device comprising:
a communication interface configured to communicate with a device comprising a replaceable component;
a user interface operable by a user; and
a controller configured to:
cause the user interface to operate in both:
a replacement enabled mode in which a replacement initiation operation on the user interface is enabled, the replacement initiation operation being an operation for initiating replacement of the replaceable component on the device; and
a replacement disabled mode in which the replacement initiation operation on the user interface is disabled.

23. A non-transitory computer-readable storage medium storing a set of program instructions for a device comprising a replaceable component and a user interface operable by a user,
the set of program instructions, when executed by a computer, causing the device to perform:
causing the user interface to operate in both:
a replacement enabled mode in which a replacement initiation operation on the user interface is enabled, the replacement initiation operation being an operation for initiating replacement of the replaceable component; and
a replacement disabled mode in which the replacement initiation operation on the user interface is disabled.

24. A method of controlling a device comprising:
a replaceable component; and
a user interface operable by a user,
the method comprising:
causing the user interface to operate in both:
a replacement enabled mode in which a replacement initiation operation on the user interface is enabled, the replacement initiation operation being an operation for initiating replacement of the replaceable component; and
a replacement disabled mode in which the replacement initiation operation on the user interface is disabled.
